(19) United States
(12) Patent Application Publication
(10) Pub. No.: US 2024/0290354 A1
(43) Pub. Date: Aug. 29, 2024

(54) METHOD FOR EDITING MULTIMEDIA RESOURCE AND ELECTRONIC DEVICE

(71) Applicant: BEIJING DAJIA INTERNET INFORMATION TECHNOLOGY CO., LTD., Beijing (CN)

(72) Inventors: Jiahui HONG, Beijing (CN); Honghao MA, Beijing (CN)

(21) Appl. No.: 18/520,025

(22) Filed: Nov. 27, 2023

(30) Foreign Application Priority Data
Feb. 27, 2023 (CN) 202310211849.2

(51) Int. Cl. G11B 27/031; G06F 3/04847

(52) U.S. Cl. CPC G11B 27/031; G06F 3/04847

(57) ABSTRACT

Provided is a method for editing a multimedia resource. The method includes: displaying a target multimedia resource to be edited and a formula control on a resource editing interface, wherein the formula control is configured to provide editing formulas for the target multimedia resource, and the editing formulas are generated based on filters indicated by a filter application operation and resource processing parameters indicated by an adjustment operation within a history time period; displaying, in response to a trigger operation on the formula control, the editing formulas on the resource editing interface; and editing, in response to a select operation on any of the editing formulas, the target multimedia resource based on a filter and resource processing parameters in the editing formula.

This application is based on and claims priority to Chinese Patent Application No. 202310211849.2, filed on Feb. 27, 2023, the disclosure of which is herein incorporated by reference in its entirety.

### TECHNICAL FIELD

The present disclosure relates to the field of multimedia technologies, and in particular, to a method for editing a multimedia resource and an electronic device.

### BACKGROUND

With the development of multimedia technologies, more users are accustomed to recording life through video. Before the video is released, a user usually acquires a video to be distributed by editing multimedia resources such as an original video or a plurality of original pictures through a video editing application. Editing generally includes operations such as adding a filter, adjusting the contrast, and adjusting the color temperature. Every time when a user edits the video, the user needs to add the filter again, and readjust the contrast, the color temperature, and other parameters.

### SUMMARY

The present disclosure provides a method for editing a multimedia resource and an electronic device. The technical solutions of the present disclosure are as follows:

According to some embodiments of the present disclosure, a method for editing a multimedia resource is provided. The method includes:
displaying a target multimedia resource to be edited and a formula control on a resource editing interface, wherein the formula control is configured to provide editing formulas for the target multimedia resource, and the editing formulas are generated based on filters indicated by a filter application operation and resource processing parameters indicated by an adjustment operation within a history time period;
displaying, in response to a trigger operation on the formula control, the editing formulas on the resource editing interface; and
editing, in response to a select operation on any of the editing formulas, the target multimedia resource based on a filter and resource processing parameters in the editing formula.

According to another aspect of embodiments of the present disclosure, an apparatus for editing a multimedia resource is provided. The apparatus includes:
a display unit, configured to display a target multimedia resource to be edited and a formula control on a resource editing interface, wherein the formula control is configured to provide editing formulas for the target multimedia resource, and the editing formulas are generated based on filters indicated by a filter application operation and resource processing parameters indicated by an adjustment operation within a history time period;
the display unit, further configured to display, in response to a trigger operation on the formula control, the editing formulas on the resource editing interface; and
an editing unit, configured to edit, in response to a select operation on any of the editing formulas, the target multimedia resource based on a filter and resource processing parameters in the editing formula.

According to another aspect of the embodiments of the present disclosure, an electronic device is provided. The electronic device includes:
one or more processors; and
a memory, configured to store program codes executable on the one or more processors;
wherein the one or more processors, when executing the program codes, are caused to perform;
displaying a target multimedia resource to be edited and a formula control on a resource editing interface, wherein the formula control is configured to provide editing formulas for the target multimedia resource, and the editing formulas are generated based on filters indicated by a filter application operation and resource processing parameters indicated by an adjustment operation within a history time period;
displaying, in response to a trigger operation on the formula control, the editing formulas on the resource editing interface; and
editing, in response to a select operation on any of the editing formulas, the target multimedia resource based on a filter and resource processing parameters in the editing formula.

According to another aspect of embodiments of the present disclosure, a non-transitory computer-readable storage medium storing instruction is provided. The instructions, when executed by a processor of an electronic device, cause the electronic device to perform:
displaying a target multimedia resource to be edited and a formula control on a resource editing interface, wherein the formula control is configured to provide editing formulas for the target multimedia resource, and the editing formulas are generated based on filters indicated by a filter application operation and resource processing parameters indicated by an adjustment operation within a history time period;
displaying, in response to a trigger operation on the formula control, the editing formulas on the resource editing interface; and
editing, in response to a select operation on any of the editing formulas, the target multimedia resource based on a filter and resource processing parameters in the editing formula.

### BRIEF DESCRIPTION OF THE DRAWINGS

The accompanying drawings, which are incorporated in and constitute a part of the specification, illustrate embodiments consistent with the present disclosure and, together with the description, serve to explain the principles of the present disclosure and are not construed as limiting the present disclosure.

FIG. 1 is a schematic diagram of an environment for implementing a method for editing a multimedia resource according to some embodiments;

FIG. 2 is a flowchart showing a method for editing a multimedia resource according to some embodiments;

FIG. 3 is a flowchart showing another method for editing a multimedia resource according to some embodiments;

FIG. 4 is a schematic diagram of a formula control according to some embodiments;

FIG. 5 is a schematic diagram of another formula control according to some embodiments;

FIG. 6 is a schematic diagram of editing formulas according to some embodiments;

FIG. 7 is a schematic diagram for managing editing formulas according to some embodiments;

FIG. 8 is a schematic diagram for adjusting a filter according to some embodiments;

FIG. 9 is a schematic diagram for adjusting resource processing parameters according to some embodiments;

FIG. 10 is a schematic diagram of combined labels according to some embodiments;

FIG. 11 is a schematic diagram of a formula storage control according to some embodiments;

FIG. 12 is a flowchart showing the process of editing a multimedia resource according to some embodiments;

FIG. 13 is a block diagram of an apparatus for editing a multimedia resource according to some embodiments;

FIG. 14 is a block diagram of another apparatus for editing a multimedia resource according to some embodiments; and

FIG. 15 is a block diagram of a terminal according to some embodiments.

### DETAILED DESCRIPTION

It should be noted that the information (including, but not limited to, user device information, user personal information, etc.), data (including, but not limited to, data for analysis, stored data, displayed data, etc.) and signals, which are referred to in the present disclosure, are authorized by the user or fully authorized by various parties, and the collection, use and processing of the relevant data are required to comply with relevant laws and regulations and standards in relevant countries and regions. For example, the parameters indicated by the filter application operation and the adjustment operation, and the editing formulas referred to in the present disclosure are acquired under full authorization.

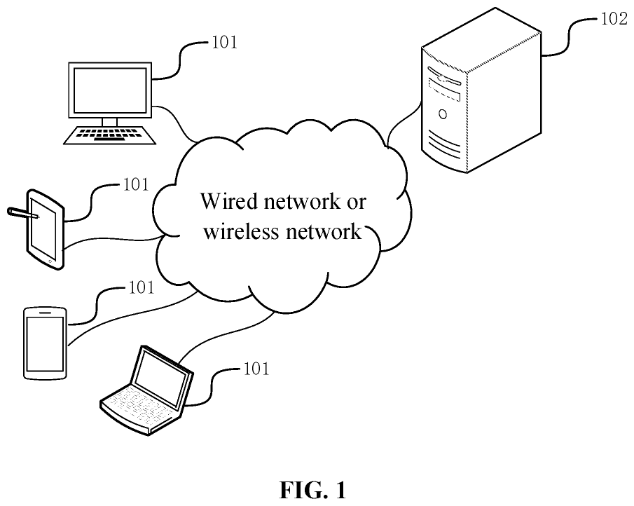

FIG. 1 is a schematic diagram of an environment for implementing a method for editing a multimedia resource according to some embodiments. Taking an electronic device serving as a terminal as an example, referring to FIG. 1, the implementation environment specifically includes a terminal 101 and a server 102.

The terminal 101 is an electronic device, that is, the terminal 101 is at least one of a smart phone, a smart watch, a desktop computer, a laptop computer, an MP3 player (moving picture experts group audio layer III), an MP4 (moving picture experts group audio layer IV) player, a laptop portable computer, and other devices. An application program supporting the editing of multimedia resources is installed on the terminal 101. A user logs in the application program with the terminal 101 to acquire services provided by the application program. The terminal 101 is in communication with the server 102 via a wireless or wired network and further acquires a filter required for a multimedia resource to be edited from the server 102. The terminal 101 edits the multimedia resource by using the acquired filter and adjusting parameters such as a contrast and a saturation of the multimedia resource through the application program.

The terminal 101 generally refers to one of a plurality of terminals, and the embodiments of the present disclosure are illustrated only by using the terminal 101. Those skilled in the art appreciate that a quantity of the terminals is more or fewer. For example, the quantity of the terminals may be only a few, or the quantity of the devices may be tens or hundreds, or more, and the quantity and the type of the terminals are not limited in the embodiments of the present disclosure.

The server 102 is at least one of a server, a plurality of servers, a cloud computing platform, and a virtualization center. The server 102 is in communication with the terminal 101 and other terminals via a wireless or wired network, and the server 102 transmits filters to the terminal 101 to provide a material for the terminal 101 to edit a video. In some embodiments, the quantity of the servers described above is more or less, which is not limited in the embodiments of the present disclosure. In some embodiments, the server 102 further includes other functional servers in order to provide more comprehensive and diverse services.

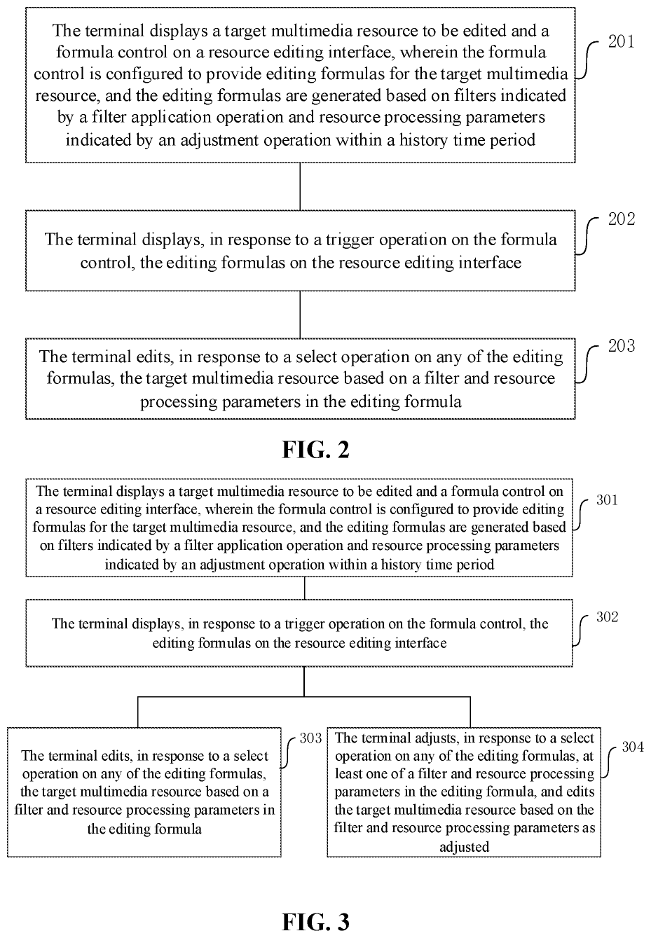

FIG. 2 is a flowchart showing a method for editing a multimedia resource according to some embodiments. Referring to FIG. 2, the method for editing a multimedia resource is applicable to a terminal, and includes the following steps.

In step 201, the terminal displays a target multimedia resource to be edited and a formula control on a resource editing interface, wherein the formula control is configured to provide editing formulas for the target multimedia resource, and the editing formulas are generated based on filters indicated by a filter application operation within a history time period and resource processing parameters indicated by an adjustment operation within a history time period.

In the embodiments of the present disclosure, the target multimedia resource to be edited may be a video or images, which is not limited in the embodiments of the present disclosure. The terminal displays the resource editing interface in response to an edit operation on the target multimedia resource. The target multimedia resource to be edited and the formula control are displayed on the resource editing interface. The display position of the target multimedia resource and the display position of the formula control are not limited in the embodiments of the present disclosure. The terminal provides the user with editing formulas in the case that the formula control is triggered. The editing formulas are generated based on the parameters indicated by the filter application operation and the adjustment operation triggered by the user within the history time period. That is, in the case that the user edits a certain multimedia resource, the user can select a filter for the multimedia resource and adjusts the resource processing parameters for the multimedia resource. The terminal generates editing formulas based on the filter selected by the user and the resource processing parameters corresponding to the adjustment operation. The resource processing parameters for the multimedia resource may include a contrast, a saturation, an exposure degree, or the like, which are not limited in the embodiments of the present disclosure.

In step 202, the terminal displays, in response to a trigger operation on the formula control, editing formulas on the resource editing interface.

In the embodiments of the present disclosure, in the case that the formula control is triggered, the terminal displays editing formulas on the resource editing interface. In some embodiments, the terminal displays a plurality of editing formulas if the editing formulas are available. The quantity of the editing formulas is not limited in the embodiments of the present disclosure. The editing formulas may be displayed in parallel in a row on the resource editing interface, or may be disposed on the resource editing interface according to the sequence of time when the editing formular was generated, which is not limited in the embodiments of the present disclosure.

In step 203, the terminal edits, in response to a select operation on any of the editing formulas, the target multimedia resource based on a filter and resource processing parameters in the editing formula.

In the embodiments of the present disclosure, for the displayed editing formulas, in the case that the editing formula is selected, the terminal edits the target multimedia resource according to parameters indicated by a filter application operation and an adjustment operation in the editing formula. That is, the terminal processes the target multimedia resource according to the filter indicated by the filter application operation and the resource processing parameters indicated by the adjustment operation.

The embodiments of the present disclosure provide a method for editing a multimedia resource, in which an editing formula is generated based on a filter and resource processing parameters which are used by a user within a history time period and are provided for the editing, and a target multimedia resource is edited based on the editing formula. As the editing formula is an editing method used by the user within a history time period, the target multimedia resource is directly edited by using the editing formula, which not only conforms to the user's habits, but also does not need to manually adjust the settings every time, which makes the operation simple, improving the human-computer interaction efficiency, thereby improving the editing efficiency of multimedia resources.

In some embodiments, the displaying the target multimedia resource to be edited and the formula control on the resource editing interface includes:
displaying, in response to an edit operation on the target multimedia resource to be edited, the resource editing interface, wherein the target multimedia resource and a filter control are displayed on the resource editing interface; and
displaying, in response to a trigger operation on the filter control, the formula control on an editing panel of the resource editing interface, wherein the formula control is displayed in a filter option of the editing panel in the form of a filter type label.

According to the embodiments provided in the present disclosure, the formula control is displayed in the filter option of the editing panel in the form of the filter type label, such that the editing formula provided by the formula control is embedded in the existing filter function in the form of a filter. In this way, other display space is not occupied, the underlying logic in the current applications is not changed, thereby reducing the development cost.

In some embodiments, the displaying the target multimedia resource to be edited and the formula control on the resource editing interface includes:
displaying, in response to an edit operation on the target multimedia resource to be edited, the resource editing interface, wherein the target multimedia resource and an adjust control are displayed on the resource editing interface;
displaying, in response to a trigger operation on the adjust control, an editing panel on the resource editing interface, wherein an adjust option and a filter option control are displayed on the editing panel, and the adjust option is configured to adjust parameters of the target multimedia resource; and
replacing, in response to a select operation on the filter option control, the adjust option on the editing panel with a filter option, wherein the filter option includes the formula control, and the formula control is displayed in the filter option in the form of a filter type option.

According to the embodiments provided in the present disclosure, in the process of editing the target multimedia resource, the filter option control is displayed on the editing panel at the same time when the adjust option is provided. That is, the adjust option can be switched to the filter option. In this way, in the case that the adjust option is displayed on the editing panel, the filter option control can be triggered to display the filter option on the editing panel to select the filter, thus the user does not need to go through the steps of returning to the editing interface before the display of the editing panel and then entering the editing panel through the filter control, which makes the operation simple, and improves the editing efficiency. Moreover, as the formula control is displayed on the filter option of the editing panel in the form of a filter type label such that the editing formula provided by the formula control is embedded in the existing filter function in the form of a filter, in this way, other display space is not occupied, the underlying logic in the current applications is unchanged, thereby reducing the development cost.

In some embodiments, the displaying the formula control on the editing panel includes:
displaying, in the case that the at least one editing formula is stored, the formula control to be in a triggerable state on the editing panel; and
displaying, in the case that the at least one editing formula is not stored, the formula control to be in a non-triggerable state on the editing panel.

According to the embodiments provided in the present disclosure, in the case that the editing formula is stored, the formula control is in a triggerable state so as to provide the editing formula for a user; in the case that no editing formula is stored, the formula control is in a non-triggerable state, such that the function of providing the editing formula is turned off in the case that no editing formula is stored, thereby reducing the running consumption.

In some embodiments, the method further includes:
displaying, in response to the trigger operation on the formula control, prompt information in the case that the formula control is in the non-triggerable state, wherein the prompt information is configured to prompt that no editing formula is stored at the current moment.

According to the embodiments provided in the present disclosure, in the case that no editing formula is stored and the formula control is triggered by the user, the prompt information is displayed to prompt the user in time that no editing formula is stored at the current moment, in this way, multiple triggering operations by a user are avoided, which saves time, improves the efficiency of acquiring information by the user, and enable the user to perform other edit operations in time, thereby improving the editing efficiency of multimedia resources.

In some embodiments, the displaying, in response to the trigger operation on the formula control, the editing formulas on the resource editing interface includes:
acquiring, in response to the trigger operation on the formula control, generation times of the editing formulas, wherein the generation time is the time when a formula was generated; and
displaying, according to a reverse order of the generation time starting with a latest generation time, the editing formulas on the resource editing interface.

According to the embodiments provided in the present disclosure, as the probability that the latest generated editing formula more likely meets the user's requirements is higher, the editing formulas are displayed according to the generation times of the editing formulas in a reverse order, such that the latest generated editing formula is preferentially displayed, the user finds the editing formula meeting the requirements more quickly, thereby improving the editing efficiency of multimedia resources.

In some embodiments, the displaying, in response to the trigger operation on the formula control, the editing formulas on the resource editing interface includes:
acquiring, in response to the trigger operation on the formula control, use frequencies of the editing formulas; and
displaying, according to an order from high use frequency to low use frequency, the editing formulas on the resource editing interface.

According to the embodiments provided in the present disclosure, the higher the use frequency of the editing formula is, the more the editing formula accords with the use habit of the user, and the editing formulas are displayed according to the use frequencies of the editing formulas in an order from high use frequency to low use frequency, such that the editing formula with the highest use frequency is preferentially displayed, and the user can find the editing formula which accords with the habit more quickly, thereby improving the editing efficiency of multimedia resources.

In some embodiments, the displaying, in response to the trigger operation on the formula control, the editing formulas on the resource editing interface includes:
acquiring, in response to the trigger operation on the formula control, history resource types corresponding to the editing formulas, wherein the history resource type corresponding to each editing formula is a type of a multimedia resource edited based on the editing formula within a history time period; and
displaying, based on the history resource types corresponding to the editing formulas and a type of the target multimedia resource, the editing formulas on the resource editing interface.

According to the embodiments provided in the present disclosure, the editing formulas used by a user can be different for the editing of different types of multimedia resources, and the type of the multimedia resource edited based on the editing formula within the history time period is acquired, such that the editing formula suitable for the editing specific type of the multimedia resource is determined, and then the editing formula is displayed according to the type of the target multimedia resource to be edited currently, such that the editing formula conforming to the target multimedia resource is preferentially displayed, and the user finds the editing formula conforming to the habit more quickly, thereby improving the editing efficiency of the multimedia resource.

In some embodiments, editing, in response to the select operation on any of the editing formulas, the target multimedia resource based on the filter and the resource processing parameters in the editing formula includes:
displaying, in response to the select operation on any of the editing formulas, a filter bar of the editing formula, wherein a slide mark is displayed in the filter bar;
adjusting, in response to a slide operation on the slide mark, a filter parameter corresponding to the filter in the editing formula, wherein the filter parameter indicates a strength of the filter applied in the editing formula; and
editing, based on the filter parameter as adjusted and the resource processing parameters in the editing formula, the target multimedia resource.

According to the embodiments provided in the present disclosure, in the process of editing the target multimedia resource by adopting the editing formula, the user adjusts the strength of the filter in the editing formula according to the requirements of the user itself by displaying the filter bar of the editing formula, such that the target multimedia resource is edited according to the adjusted filter and the original resource processing parameters in the editing formula, in this way, the operation is simple, and the user's requirements and habit are met.

In some embodiments, editing, in response to the select operation on any of the editing formulas, the target multimedia resource based on the filter and the resource processing parameters in the editing formula includes:
displaying, in response to a trigger operation on an adjusting-option control, adjust options in a case that any of the editing formulas is selected;
setting, in response to the trigger operation on any of the adjust options, resource processing parameters for the target multimedia resource; and
editing, based on the editing formula and the resource processing parameters corresponding to the adjust options, the target multimedia resource.

According to the embodiments provided in the present disclosure, in the process of editing the target multimedia resource by adopting the editing formula, the adjusting-option control is triggered to display at least one adjust option, such that the resource processing parameters for the target multimedia resource are set according to the requirements of the user itself, and then the editing is performed according to the editing formula and the set resource processing parameters, in this way, the purpose of performing secondary adjustment according to the user's requirements based on the selected editing formula is achieved, and the user's intention is met.

In some embodiments, editing, based on the editing formula and the resource processing parameters corresponding to the adjust options, the target multimedia resource includes:
acquiring resource processing parameters indicated by the adjustment operation in the editing formula;
acquiring target processing parameters by performing weighted summation on the resource processing parameters indicated by the adjustment operation and the resource processing parameters corresponding to the adjust options; and
editing, based on the filter in the editing formula and the target processing parameters, the target multimedia resource.

According to the embodiments provided in the present disclosure, adjusting parameters indicated by the adjustment operation in the editing formula and adjusting parameters corresponding to the adjust options in the secondary adjustment are subjected to weighted summation, and then the target adjustment parameters acquired based on the weighted summation and the filter in the editing formula are adopted for editing, such that the edited multimedia resource is generated by fusing the editing formula and the parameters corresponding to the resource processing parameters adjusted by the user, in this way, the user's intention is met.

In some embodiments, editing, based on the editing formula and the resource processing parameters corresponding to the adjust options, the target multimedia resource includes:
acquiring resource processing parameters indicated by the adjustment operation in the editing formula; and
editing, in a case that at least one adjust option is repeated with adjust options corresponding to the resource processing parameters in the editing formula, the target multimedia resource by taking the resource processing parameters corresponding to the at least one adjust option as a reference.

According to the embodiments provided in the present disclosure, in the process of editing the target multimedia resource by adopting the editing formula, in the case that the user adjusts the target multimedia resource again, as the resource processing parameters adjusted by the user better accord with the user's intention, the editing is performed by taking the resource processing parameters adjusted by the user as a reference in the case that at least one adjust option adjusted by the user is repeated with the adjust options corresponding to the resource processing parameters in the editing formula, such that the edited target multimedia resource better accords with the user's intention.

In some embodiments, the method includes:
displaying, in response to the trigger operation on any of the adjust options, combined labels on a drawing track corresponding to the target multimedia resource in the case that any of the editing formulas is selected, wherein the drawing track includes multi-frame images of the target multimedia resource, the combined labels are marked with a name and an adjusting identifier of the editing formula, and the adjusting identifier indicates that an adjustment operation is present in the editing process of the target multimedia resource.

According to the embodiments provided in the present disclosure, the combined labels are displayed on the drawing track corresponding to the target multimedia resource, such that the editing formula and the adjustment operation applied when the target multimedia resource is edited are visually displayed, and therefore the display mode of the editing information is enriched, and the user visually knows the editing mode of each frame of image in the target multimedia resource conveniently.

In some embodiments, a formula storage control is displayed on the resource editing interface; and
the method further includes:
generating, in response to a trigger operation on the formula storage control, a new editing formula based on the filter parameter or resource processing parameters as adjusted.

According to the embodiments provided in the present disclosure, the formula storage control is provided such that a new editing formula is generated based on the filter parameters or resource processing parameters adjusted by the user, and the filter and the resource processing parameters satisfied by the user are stored, so that the target multimedia resource is directly edited through the filter and the resource processing parameters satisfied by the user in the case of editing the multimedia resource next time, in this way, the user's requirements are met, the setting is not required to be manually adjusted every time, which makes the operation simple and improves the man-machine interaction efficiency, thereby improving the editing efficiency of the multimedia resource.

FIG. 2 is a flowchart illustrating only a basic flow of the present disclosure, and the embodiments provided by the present disclosure are further explained below based on a specific implementation manner; FIG. 3 is a flowchart showing another method for editing a multimedia resource according to some embodiments. Taking the electronic device serving as a terminal as an example, referring to FIG. 3, the method for editing the multimedia resource includes the following steps.

In step 301, the terminal displays a target multimedia resource to be edited and a formula control on a resource editing interface, wherein the formula control is configured to provide editing formulas for the target multimedia resource, and the editing formulas are generated based on filters indicated by a filter application operation and resource processing parameters indicated by an adjustment operation within a history time period.

In the embodiments of the present disclosure, the terminal displays, in response to a edit operation on the target multimedia resource to be edited, the resource editing interface. The target multimedia resource, a filter control and an adjust control are displayed on the resource editing interface. The filter control is configured to provide filters for the target multimedia resource. The adjust control is configured to set resource processing parameters for the target multimedia resource. The resource processing parameter is a contrast, a saturation, a sharpening degree, a huc, a color temperature, or the like of the target multimedia resource, which is not limited in the embodiments of the present disclosure. The formula control is located in the filter option in the form of a filter type label, i.e., the editing formula serves as a filter. Correspondingly, the terminal displays, in response to a trigger operation on the filter control, the formula control on the resource editing interface. Or, the formula control is located in the adjust option in the form of an adjust option label, i.e., the editing formula serves as an adjusted resource processing parameter and is present in parallel with the adjust option such as the contrast or the saturation. Correspondingly, the terminal displays, in response to a trigger operation on the adjust control, the formula control on the resource editing interface. The display mode of the formula control is not limited in the embodiments of the present disclosure.

In some embodiments, the formula control is located in the filter option in the form of a filter type label. Namely, the editing formula is a filter type. Correspondingly, the process that the terminal displays the target multimedia resource to be edited and the formula control on the resource editing interface includes that: the terminal displays, in response to the edit operation on the target multimedia resource to be edited, the resource editing interface. The target multimedia resource and the filter control are displayed on the resource editing interface. Then, the terminal displays, in response to a trigger operation on the filter control, the formula control on a editing panel of the resource editing interface. The formula control is displayed on the filter option of the editing panel in the form of a filter type label. According to the embodiments provided in the present disclosure, the formula control is displayed on the filter option of the editing panel in the form of the filter type label, such that the editing formula provided by the formula control is embedded in the existing filter function in the form of a filter. In this way, other display space is not occupied, the underlying logic in the current applications is not changed, thereby reducing the development cost.

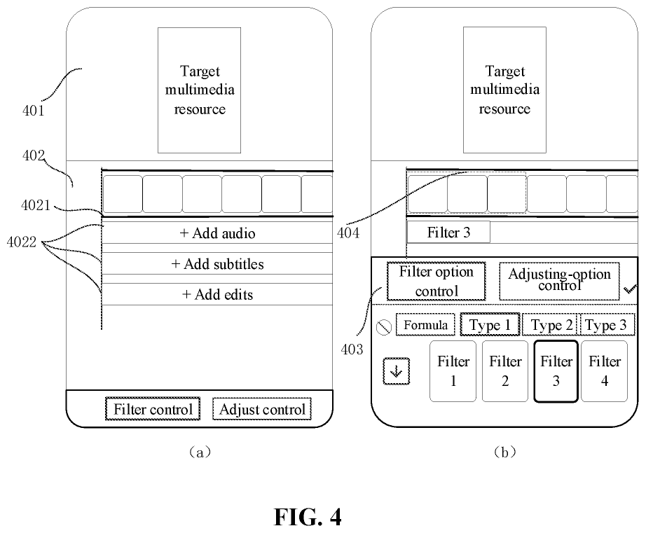

For example, FIG. 4 is a schematic diagram of a formula control according to some embodiments. Referring to FIG. 4, FIG. 4(a) exemplarily illustrates a schematic diagram of a resource editing interface in case of triggering an edit operation on a target multimedia resource. The resource editing interface includes an effect presentation area 401 and an operation presentation area 402. The target multimedia resource is displayed on the effect presentation area 401 for presenting the editing effect of the target multimedia resource. A drawing track 4021 and time lines 4022 for the target multimedia resource are displayed on the operation presentation area 402. The drawing track 4021 of the target multimedia resource includes a plurality of frames of images in the target multimedia resource. The plurality of frames of images are disposed in time sequence. The audio, subtitles, and edits added by the user are further displayed on the operation presentation area 402. Any one of the audio, subtitles and edits is disposed according to the time lines for the target multimedia resource, wherein the edits include at least one of a selected filter and resource processing parameters indicated by adjusting. A filter control and an adjust control are further displayed at the bottom of the resource editing interface. The terminal displays, in response to the trigger operation on the filter control, an editing panel 403 on the resource editing interface as shown in FIG. 4(b).

Referring to FIG. 4(b), a filter option control and an adjusting-option control are displayed on the editing panel 403. The filter option control on the editing panel 403 is in a selected state as a result of entering the editing panel 403 by triggering the filter control. In this case, the terminal displays a plurality of filter type labels on the editing panel 403. The quantity of filter types is not limited in the embodiments of the present disclosure. For example, a plurality of filter type labels include a formula control, a type 1 control, a type 2 control, and a type 3 control. The terminal displays, in response to a trigger operation on the type 1 control, at least one filter belonging to the corresponding filter type. In the case that at least one frame of image in the drawing track 4021 is selected in the editing frame 404 (dashed frame), the terminal edits, in response to a select operation on a filter 3, the at least one frame of image selected in the editing frame 404 based on the filter 3. The terminal further displays the label of the selected filter 3 on the time line corresponding to at least one frame of image.

In some embodiments, a filter option control and an adjusting-option control are displayed on the editing panel. In the case that the adjust control is triggered to enter the editing panel, the terminal switches the adjust option on the editing panel into the filter option through the filter option control on the editing panel, such that a formula control is displayed, and editing is performed by selecting an editing formula provided by the formula control. Correspondingly, the process that the terminal displays the target multimedia resource to be edited and the formula control on the resource editing interface includes: the terminal displays, in response to the edit operation on the target multimedia resource to be edited, the resource editing interface. The target multimedia resource and the adjust control are displayed on the resource editing interface. Then, the terminal displays, in response to the trigger operation on the adjust control, the editing panel on the resource editing interface. The adjust option and the filter option control are displayed on the editing panel, and the adjust option is configured to adjust the resource processing parameters for the target multimedia resource. Then, the terminal replaces, in response to a select operation on the filter option control, the adjust option on the editing panel with the filter option. The filter option includes a formula control. The formula control is displayed on the filter option in the form of a filter type label. According to the embodiments provided in the present disclosure, in the process of editing the target multimedia resource, the filter option control is displayed on the editing panel at the same time, such that in the case that the adjust option is displayed on the editing panel, the filter option control is triggered to display the filter option on the editing panel to select the filter, and the editing panel does not need to be entered through the filter control before the editing panel is not displayed, which makes the operation simple, and improves the editing efficiency. Moreover, as the formula control is displayed on the filter option of the editing panel in the form of a filter type label such that the editing formula provided by the formula control is embedded in the existing filter function in the form of a filter, in this way, other display space is not occupied, the underlying logic in the current applications is unchanged, thereby reducing the development cost.

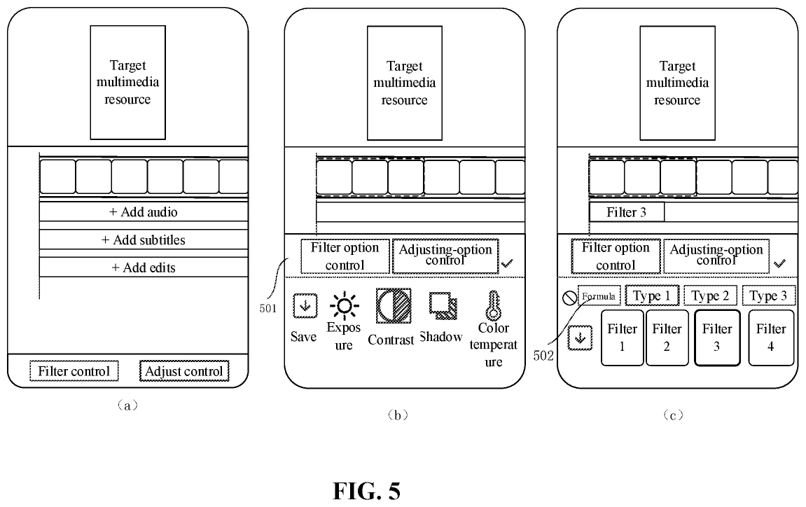

For example, FIG. 5 is a schematic diagram of another formula control according to some embodiments. Referring to FIG. 5, FIG. 5(a) exemplarily illustrates a schematic diagram of a resource editing interface in response to triggering an edit operation on a target multimedia resource. FIG. 5(a) is the same as FIG. 4(a), which is not repeated herein. A filter control and an adjust control are displayed at the bottom of the resource editing interface. The terminal displays, in response to the trigger operation on the adjust control, the editing panel 501 on the resource editing interface. Referring to FIG. 5(b), a filter option control and an adjusting-option control are displayed on the editing panel 501. The adjusting-option control on the editing panel 501 is in a selected state as a result of entering the editing panel 501 by triggering the adjust control. In this case, the terminal displays a plurality of adjust options on the editing panel 501. The quantity of adjust options is not limited in the embodiments of the present disclosure. For example, a plurality of adjust options include an exposure control, a contrast control, a shadow control, and a color temperature control. The terminal adjusts, in response to a trigger operation on the control corresponding to any of the adjust options, the resource processing parameters corresponding to the adjust option. The terminal switches, in response to a trigger operation on the filter option control, the adjust option on the editing panel 501 into the filter option. Referring to FIG. 5(c), the terminal displays a plurality of filter type labels on the editing panel 501. The formula control 502 is displayed on the editing panel as a filter type label. The filter option control in the editing panel 501 described above serves as a secondary filter control; and the adjusting-option control serves as a secondary adjust control.

The formula control described above is in a triggerable state all the time, and whether the formula control is triggerable is also determined according to a storage condition of the editing formula, which is not limited in the embodiments of the present disclosure. In some embodiments, whether the formula control is triggerable is determined according to the storage condition of the editing formula. Correspondingly, in the case that at least one editing formula is stored, the terminal displays the formula control to be in a triggerable state on the editing panel. In the case that at least one editing formula is not stored, the terminal displays the formula control to be in a non-triggerable state on the editing panel. According to the embodiments provided in the present disclosure, in the case that the editing formula is stored, the formula control is in a triggerable state so as to provide the editing formula for a user; in the case that no editing formula is stored, the formula control is in a non-triggerable state, such that the function of providing the editing formula is turned off in the case that no editing formula is stored, thereby reducing the running consumption.

Referring to FIG. 3, in the case that the formula control is in a triggerable state, the terminal performs, in response to a trigger operation on the formula control, step 302 to display the at least one stored editing formula. In the case that the formula control is in a non-triggerable state, the terminal displays, in response to a trigger operation on the formula control, prompt information, wherein the prompt information is configured to prompt that no editing formula is stored at the current moment. According to the embodiments provided in the present disclosure, in the case that no editing formula is stored and the formula control is triggered by the user, the prompt information is displayed to prompt the user in time that no editing formula is stored at the current moment, in this way, multiple triggers by a user for misoperation are avoided, which saves time, improves the efficiency of acquiring information by the user, and enable the user to perform other edit operations in time, thereby improving the editing efficiency of multimedia resources.

For example, the prompt information is a Toast prompt. The content of the prompt information is “please add an editing formula first”. The embodiments of the present disclosure do not limit the specific content, display position, and display mode of the prompt information.

In step 302, the terminal displays, in response to a trigger operation on the formula control, at least one editing formula on the resource editing interface.

In the embodiments of the present disclosure, in the case that the formula control is triggered, the terminal displays at least one editing formula on the editing panel of the resource editing interface. The display form, quantity, name, and arrangement of the editing formulas are not limited in the embodiments of the present disclosure.

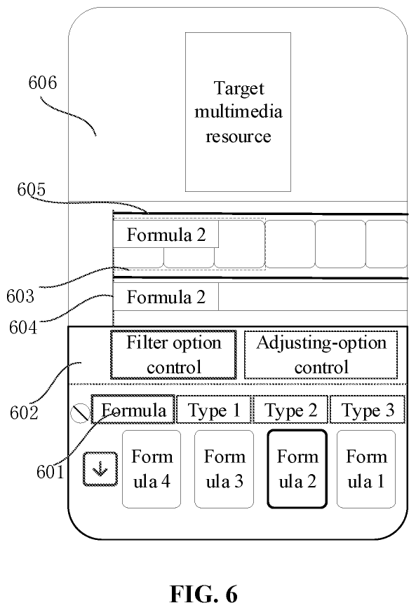

For example, FIG. 6 is a schematic diagram of editing formulas according to some embodiments. Referring to FIG. 6, the terminal displays, in response to a trigger operation on a formula control 601, four editing formulas which are formula 1, formula 2, formula 3, and formula 4, on an editing panel 602 of the resource editing interface. In the illustrated example, the four editing formulas are displayed in parallel on the resource editing interface, that is, the editing formulas are arranged in a row. The currently-displayed editing formula is slidable. The terminal displays, in response to a slide operation on the currently-displayed editing formula, other editing formulas.

The editing formulas described above are displayed according to at least one of generation time, use frequencies, and applicable resource types, which is not limited in the embodiments of the present disclosure.

In some embodiments, the editing formulas are displayed on the resource editing interface based on the generation times. Correspondingly, the process that the terminal displays the editing formulas on the resource editing interface includes: the terminal acquires, in response to the trigger operation on the formula control, the generation time for the editing formulas. The generation time is the time when the editing formulas were used to edit the multimedia resources by the user. Then, the terminal displays the editing formulas on the resource editing interface according to the reverse order of the generation times with the latest generation time arranged first. According to the embodiments provided in the present disclosure, as the probability that the latest generated editing formula meets the user's requirements is higher, the editing formulas are displayed according to the generation times of the editing formulas in a reverse order, such that the latest generated editing formula is preferentially displayed, the user can find the editing formula meeting the requirements more quickly, thereby improving the editing efficiency of multimedia resources.

In some embodiments, the editing formulas are displayed on the resource editing interface based on the use frequencies. Correspondingly, the process that the terminal displays the editing formulas on the resource editing interface includes: the terminal acquires, in response to the trigger operation on the formula control, the use frequencies for the editing formulas. Then, the terminal displays, according to an order of the high use frequencies to low use frequencies, the editing formulas on the resource editing interface. According to the embodiments provided in the present disclosure, the higher the use frequency of the editing formula is, the more likely that the editing formula accords with the use habit of the user, and the editing formulas are displayed according to the order of use frequencies of the editing formulas, such that the editing formula with the highest use frequency is preferentially displayed, and the user can find the editing formula which accords with the habit more quickly, thereby improving the editing efficiency of multimedia resources.

In some embodiments, the editing formulas are displayed on the resource editing interface based on the applicable resource type. Correspondingly, the process that the terminal displays the editing formulas on the resource editing interface includes: the terminal acquires, in response to the trigger operation on the formula control, the history resource types corresponding to the editing formulas. Then, the terminal displays, based on the history resource types corresponding to the editing formulas and a type of the target multimedia resource, the editing formulas on the resource editing interface, wherein the history resource type corresponding to each editing formula is a type of the multimedia resource edited based on the editing formula within the history time period. According to the embodiments provided in the present disclosure, the editing formulas may be different for the editing of different types of multimedia resources, thus the type of the multimedia resource edited based on the editing formula within the history time period is acquired, such that the editing formula suitable for the editing of certain type of multimedia resource is determined, and then the editing formula is displayed according to the type of the target multimedia resource to be edited currently, such that the editing formula conforming to the target multimedia resource is preferentially displayed, and the user can find the editing formula conforming to the habit more quickly, thereby improving the editing efficiency of the multimedia resource.

Referring to FIG. 3, the terminal directly edits the target multimedia resource based on the editing formula as provided; namely, the terminal continues to perform step 303. The terminal also adjusts at least one of the filter and the resource processing parameters in the case that any of the editing formulas is selected, and edits the target multimedia resource based on the parameters as adjusted as described step 304.

In step 303, the terminal edits, in response to a select operation on any of the editing formulas, the target multimedia resource based on a filter and resource processing parameters in the editing formula.

In the embodiments of the present disclosure, in the case that any of the editing formulas is selected, the terminal acquires the filter and the resource processing parameters in the selected editing formula. Then, the terminal edits the target multimedia resource based on the filter and the resource processing parameters in the editing formula. The method provided in the embodiments of the present disclosure stores the filters indicated by the filter application operation and the resource processing parameters indicated by the adjustment operation when the user edits the multimedia resource within the history time period, and generates the editing formulas based on the history data, and then directly edit the target multimedia resource according to the filters and the resource processing parameters that have been used by the user before by selecting the generated editing formulas, which not only conforms to the user's habits, but also does not need to manually adjust the settings every time, which makes the operation simple, improving the human-computer interaction efficiency, thereby improving the editing efficiency of multimedia resources.

Referring to FIG. 6, the terminal edits, in response to a select operation on formula 2, images of the target multimedia resource selected in the editing frame 603 (dashed frame) based on formula 2. The terminal not only displays the name of the selected formula 2 on the time line 604, but also displays the name of formula 2 on the drawing track 605 of the target multimedia resource. The plurality of frames of images in the drawing track 605 of the target multimedia resource are slidable. The terminal edits, in response to the slide operation on the plurality of frames of images of the target multimedia resource, different frames of images. In the process of sliding, the terminal also displays the editing effect of formula 2 on the effect presentation area 606.

The terminal also manages the editing formulas described above. The management includes at least one of renaming and deleting the editing formulas. The terminal displays, in response to a manage operation on any of the editing formulas, a management panel of the editing formula on the resource editing interface. A rename control and a delete control are displayed on the management panel. The terminal displays, in response to a trigger operation on the rename control, a renaming panel. An input box is displayed on the renaming panel. The terminal displays, in response to a trigger operation on the input box, a keyboard. The terminal displays, in response to a trigger operation on the keyboard, the updated formula name in the input box. The quantity of words in the name of the editing formula is not limited in the embodiments of the present disclosure. The terminal deletes, in response to a trigger operation on the delete control, the editing formula.

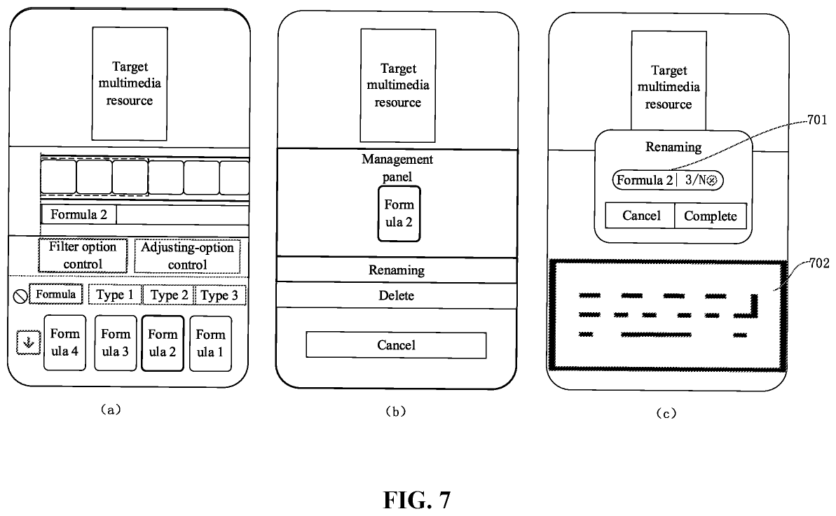

For example, FIG. 7 is a schematic diagram for managing editing formulas according to some embodiments. Referring to FIG. 7, four editing formulas, which are formula 1, formula 2, formula 3, and formula 4, are displayed on the resource editing interface. The terminal displays, in response to a manage operation on formula 2, a management panel of formula 2 on the resource editing interface as shown in FIG. 7(b). A rename control and a delete control are displayed on the management panel of formula 2. The terminal displays, in response to a trigger operation on the rename control, a renaming panel as shown in FIG. 7(c). An input box is displayed on the renaming panel. The terminal displays, in response to a trigger operation on the input box 701, a keyboard 702. The terminal displays, in response to a trigger operation on the keyboard 702, the updated formula name in the input box 701. The quantity of words in the name of formula 2 may be limited not to exceed N. The terminal updates, in response to a trigger operation on a complete control in the renaming panel, the name of formula 2. The terminal deletes, in response to a trigger operation on the delete control, formula 2. A cancel control is also displayed on the management panel of formula 2. The terminal closes, in response to a trigger operation on the cancel control, the management panel of formula 2.

Referring to FIG. 3, in step 304, in response to a select operation on any of the editing formulas, the terminal adjusts at least one of a filter and resource processing parameters in the editing formula, and edits the target multimedia resource based on the adjusted filter and resource processing parameters.

In the embodiments of the present disclosure, in the case that any of the editing formulas is selected, the user also adjusts at least one of the filter and the resource processing parameters in the editing formula according to the user's own requirements. The terminal edits, in response to an adjustment operation on at least one of the filter and the resource processing parameters in the editing formula, the target multimedia resource based on the adjusted editing formula.

In some embodiments, the terminal adjusts the strength of the filter in the editing formula. Correspondingly, the terminal displays, in response to a select operation on any of the editing formulas, a filter bar of the editing formula. A slide mark is displayed on the filter bar. The terminal adjusts, in response to a slide operation on the slide mark, filter parameters corresponding to the filter in the editing formula. The filter parameters indicate the strength of the filter applied in the editing formula. Then, the terminal edits the target multimedia resource based on the adjusted filter parameters and the resource processing parameters in the editing formula. According to the embodiments provided in the present disclosure, in the process of editing the target multimedia resource by adopting the editing formula, the user adjusts the strength of the filter in the editing formula according to the requirements of the user itself by displaying the filter bar of the editing formula, such that the target multimedia resource is edited according to the adjusted filter and the original resource processing parameters in the editing formula, in this way, the operation is simple, and the user's requirements and habit are met.

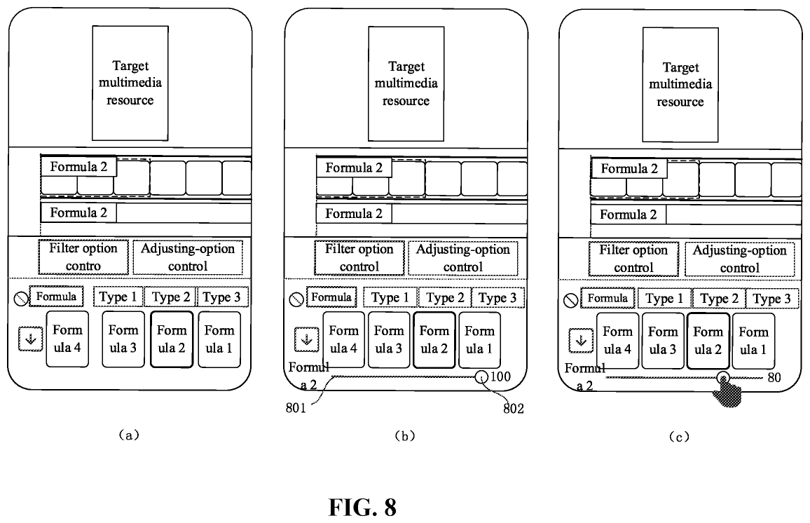

For example, FIG. 8 is a schematic diagram for adjusting a filter according to some embodiments. Referring to FIG. 8, FIG. 8(a) exemplarily illustrates a schematic diagram of a resource editing interface. A plurality of editing formulas are displayed on the resource editing interface. Taking formula 2 as an example, in response to a select operation on formula 2, the terminal displays a filter bar 801 of formula 2. Referring to FIG. 8(b), a slide mark 802 is displayed on the filter bar 801. The initial position of the slide mark 802 is at the maximum value of the filter parameters, i.e., the strength of the filter in the default editing formula is full (i.e., 100). The initial position of the slide mark 802 is not limited in the embodiments of the present disclosure. The terminal adjusts, in response to a slide operation on the slide mark 802, the strength of the filter in formula 2. Referring to FIG. 8(c), the terminal adjusts the strength of the filter in formula 2 to 80. In some embodiments, the terminal adjusts the resource processing parameters in the editing formula. Correspondingly, the terminal displays, in response to a trigger operation on an adjusting-option control, at least one adjust option in a case that any of the editing formulas is selected. The terminal sets, in response to the trigger operation on any of the adjust options, resource processing parameters for the target multimedia resource. Then, the terminal edits, based on the editing formula and the resource processing parameters corresponding to at least one adjust option, the target multimedia resource. According to the embodiments provided in the present disclosure, in the process of editing the target multimedia resource by adopting the editing formula, the adjusting-option control is triggered to display at least one adjust option, such that the resource processing parameters for the target multimedia resource are set according to the requirements of the user itself, and then the editing is performed according to the editing formula and the set resource processing parameters, in this way, the purpose of performing secondary adjustment according to the user's requirements based on the selected editing formula is achieved, and the user's intention is met.

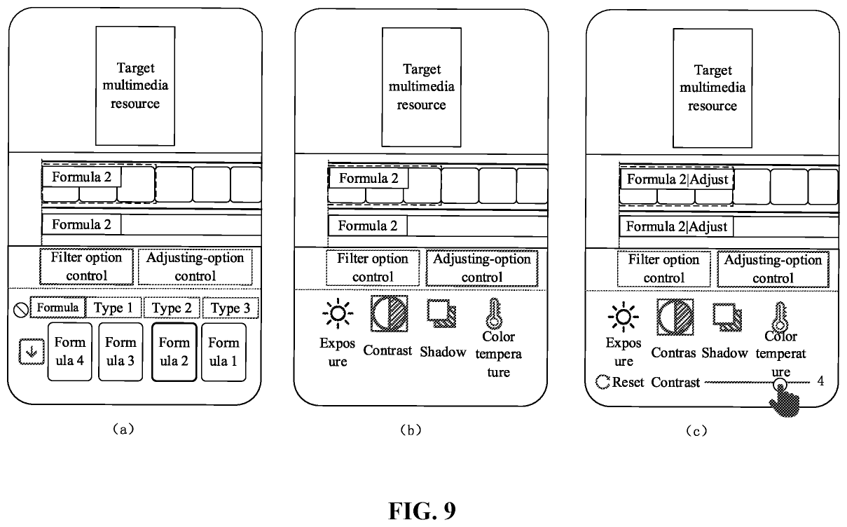

For example, FIG. 9 is a schematic diagram for adjusting resource processing parameters according to some embodiments. Referring to FIG. 9, FIG. 9(a) exemplarily illustrates a schematic diagram of a resource editing interface. A plurality of editing formulas are displayed on the resource editing interface. Taking formula 2 as an example, the terminal displays, in response to a trigger operation on an adjusting-option control, at least one adjust option in the case that formula 2 is selected. Referring to FIG. 9(b), the at least one adjust option includes four adjust options of exposure, contrast, shadow, and color temperature. Taking the contrast as an example, the terminal sets, in response to the trigger operation on the contrast, the contrast of the target multimedia resource. Referring to FIG. 9(c), the terminal sets the contrast of the target multimedia resource to four. Then, the terminal edits the target multimedia resource based on the editing formula and the numerical value corresponding to the contrast. The displayed adjust options described above are slidable, and the terminal displays, in response to the displayed adjust options, other adjust options.

During the process of editing, based on the editing formula and the resource processing parameters corresponding to adjust options, the target multimedia resource, the terminal fuses the editing formula and the resource processing parameters corresponding to the adjust options, so as to edit based on the fused parameters; or, the terminal also edits the resource by selecting appropriate parameters from the resource processing parameters corresponding to the editing formula and the at least one adjust option, which is not limited in the embodiments of the present disclosure.

In some embodiments, the terminal fuses the editing formula and the resource processing parameters corresponding to the adjust options, so as to edit based on the fused parameters. Correspondingly, the process that the terminal edits, based on the editing formula and the resource processing parameters corresponding to at least one adjust option, the target multimedia resource includes: the terminal acquires the resource processing parameters indicated by the adjustment operation in the editing formula. Then, the terminal performs weighted summation on the resource processing parameters indicated by the adjustment operation and the resource processing parameters corresponding to the adjust options to acquire target processing parameters. Then, the terminal edits the target multimedia resource based on the filter and the target processing parameters in the editing formula. According to the embodiments provided in the present disclosure, adjusting parameters indicated by the adjustment operation in the editing formula and adjusting parameters corresponding to the adjust options in the secondary adjustment are subjected to weighted summation, and then the target adjustment parameters acquired based on the weighted summation and the filter in the editing formula are adopted for editing, such that the edited multimedia resource is generated by fusing the editing formula and the parameters corresponding to the resource processing parameters adjusted by the user, in this way, the user's intention is met.

In some embodiments, the terminal edits by selecting appropriate parameters from the editing formula and the resource processing parameters corresponding to the adjust options. Correspondingly, the process that the terminal edits, based on the editing formula and the resource processing parameters corresponding to the adjust options, the target multimedia resource includes: the terminal acquires the resource processing parameters indicated by the adjustment operation in the editing formula; and the terminal edits, in the case that the at least one adjust option is repeated with the adjust options corresponding to the resource processing parameters in the editing formula, the target multimedia resource by taking the resource processing parameters corresponding to the at least one adjust option as a reference. According to the embodiments provided in the present disclosure, in the process of editing the target multimedia resource by adopting the editing formula, in the case that the user adjusts the target multimedia resource again, as the resource processing parameters adjusted by the user better accord with the user's intention, the editing is performed by taking the resource processing parameters adjusted by the user as a reference in the case that at least one adjust option adjusted by the user is repeated with the adjust options corresponding to the resource processing parameters in the editing formula, such that the edited target multimedia resource better accords with the user's intention.

In some embodiments, the terminal generates labels based on the selected filter and the adjustment operation performed during the editing process to visually present to the user the currently-applied editing mode. Correspondingly, the terminal displays, in response to the trigger operation on any of the adjust options, combined labels on a drawing track corresponding to the target multimedia resource in the case that any of the editing formulas is selected, wherein the drawing track includes multi-frame images in the target multimedia resource, the combined labels are marked with a name and an adjusting identifier of the editing formula, wherein, the adjusting identifier indicates that an adjustment operation is present in the editing process of the target multimedia resource. According to the embodiments provided in the present disclosure, the combined labels are displayed on the drawing track corresponding to the target multimedia resource, such that the editing formula and the adjustment operation applied when the target multimedia resource is edited are visually displayed, and therefore the display mode of the editing information is enriched, and the user visually knows the editing mode of each frame of image in the target multimedia resource conveniently.

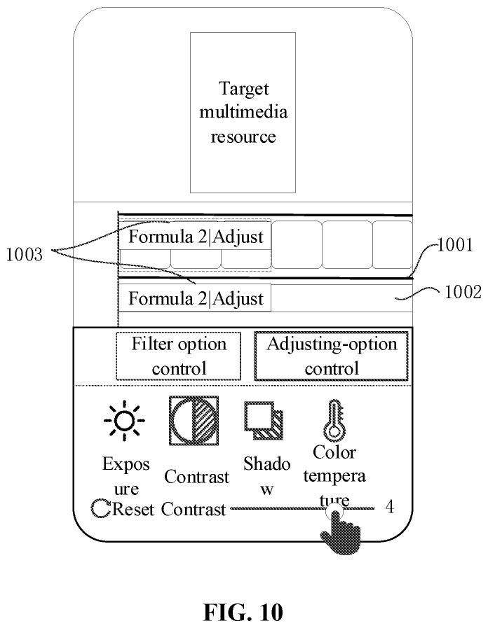

For example, FIG. 10 is a schematic diagram of combined labels according to some embodiments. Referring to FIG. 10, combined labels 1003 are displayed on both the drawing track 1001 and the time line 1002 of the target multimedia resource. The combined labels 1003 are “Formula 2|Adjust”. It can be seen that the target multimedia resource is edited based on formula 2 and the adjustment operation.

In some embodiments, a formula storage control is displayed on the resource editing interface. The terminal generates an editing formula through the formula storage control. Correspondingly, the terminal generates, in response to a trigger operation on the formula storage control, a new editing formula based on the filter parameters or resource processing parameters as adjusted. According to the embodiments provided in the present disclosure, the formula storage control is provided such that a new editing formula is generated based on the filter parameters or resource processing parameters adjusted by the user, and the filter and the resource processing parameters satisfied by the user are stored, so that the target multimedia resource is directly edited through the filter and the resource processing parameters satisfied by the user in the case of editing the multimedia resource next time, in this way, the user's requirements are met, the setting is not required to be manually adjusted every time, which makes the operation simple and improves the man-machine interaction efficiency, thereby improving the editing efficiency of the multimedia resource.

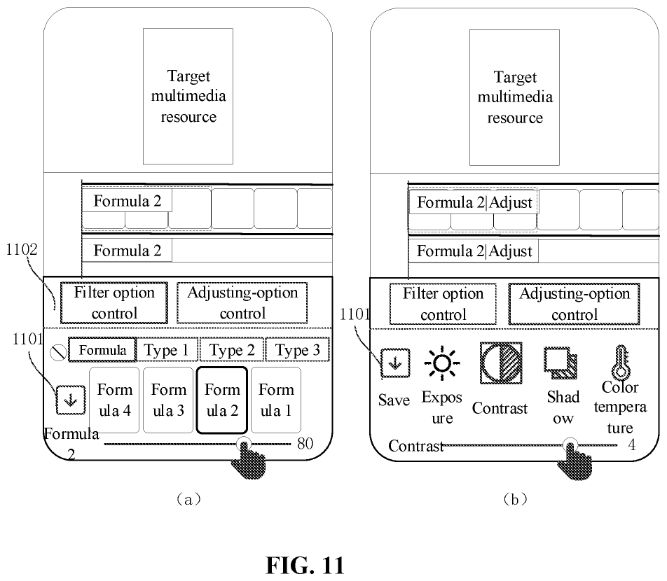

For example, FIG. 11 is a schematic diagram of a formula storage control according to some embodiments. Referring to FIG. 11(a), the formula storage control 1101 is displayed in a filter option on an editing panel 1102. Namely, the terminal stores the currently-selected filter and the set resource processing parameters in the hierarchy of filters selected for the target multimedia resource, and generates an editing formula. Referring to FIG. 11(b), the formula storage control 1101 is also displayed in an adjust option on the editing panel 1102. Namely, the terminal stores the currently-selected filter and the set resource processing parameters in the hierarchy of resource processing parameters set for the target multimedia resource, and generates an editing formula, which is not limited in the embodiments of the present disclosure. In the case that any of the filters is not selected and any of the resource processing parameters is not adjusted, the terminal displays the formula storage control to be in a non-triggerable state. Namely, the formula storage control is in a non-triggerable state in the case that any of the edit operations is not triggered.

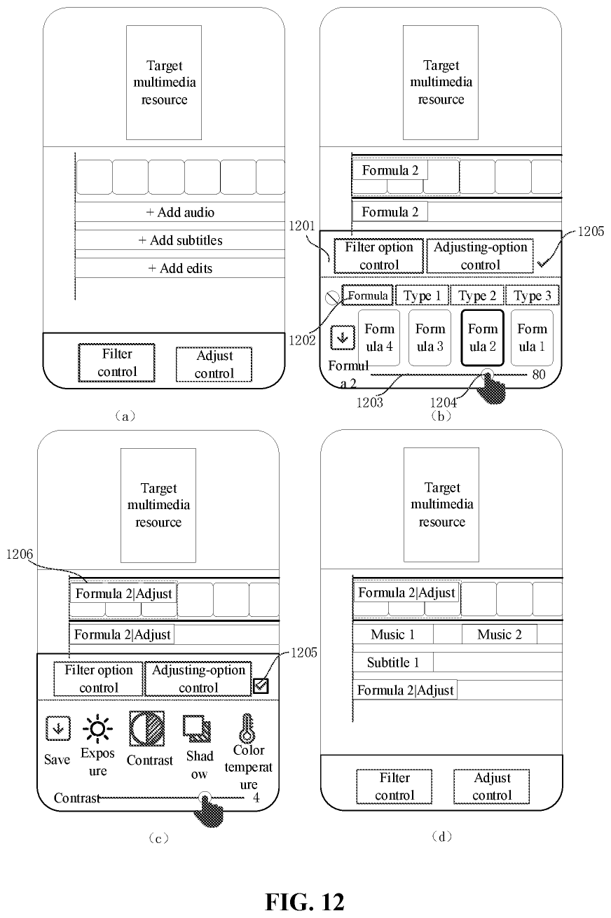

In order to more clearly describe the solutions, the following description will be made with reference to the accompanying drawings. FIG. 12 illustrates a flow of the process of editing a multimedia resource according to some embodiments. Referring to FIG. 12, FIG. 12(a) exemplarily illustrates a schematic diagram of a resource editing interface in case of triggering an edit operation on a target multimedia resource. FIG. 12(a) is the same as FIG. 4(a), which is not repeated herein. A filter control and an adjust control are further displayed at the bottom of the resource editing interface. The terminal displays, in response to the trigger operation on the filter control, an editing panel 1201 on the resource editing interface.

Referring to FIG. 12(b), a filter option control and an adjusting-option control are displayed on the editing panel. The filter option control on the editing panel is in a selected state as a result of entering the editing panel by triggering the filter control. In this case, the terminal displays a plurality of filter type labels on the editing panel. A filter option control and an adjusting-option control are displayed on the editing panel. The filter option control on the editing panel 1201 is in a selected state as a result of entering the editing panel 1201 by triggering the filter control. In this case, the terminal displays a plurality of filter type labels on the editing panel 1201. A plurality of filter type labels include a formula control 1202, a type 1 control, a type 2 control, and a type 3 control. The terminal displays, in response to a trigger operation on the formula control 1202, four editing formulas on the editing panel of the resource editing interface. Taking formula 2 as an example, in response to a select operation on formula 2, the terminal displays a filter bar 1203 of formula 2. A slide mark 1204 is displayed on the filter bar 1203. The terminal adjusts, in response to a slide operation on the slide mark 1204, the strength of the filter in formula 2. The terminal adjusts the strength of the filter in formula 2 to 80. The terminal displays, in response to the trigger operation on the adjusting-option control, at least one adjust option in the case that formula 2 is selected.

Referring to FIG. 12(c), the at least one adjust option includes four adjust options, that is, exposure, contrast, shadow, and color temperature for example. Taking the contrast as an example, the terminal sets, in response to the trigger operation on the contrast, the contrast of the target multimedia resource. In the illustrated example, the terminal sets the contrast of the target multimedia resource to four (4). After the setting of both the filter and the resource processing parameters is completed, the terminal displays, in response to a trigger operation on a complete control 1205, the resource editing interface similar to that in FIG. 12(a) again. At this time, the content shown in FIG. 12(a) is different from that before editing. Specifically, referring to FIG. 12(d), combined labels 1206 are displayed on the drawing track and the time lines corresponding to the editing in the resource editing interface are displayed, so as to visually present to the user the currently-applied editing mode.

The embodiments of the present disclosure provide a method for editing a multimedia resource, in which an editing formula generated based on a filter and resource processing parameters used by a user to edit the multimedia resource within a history time period is provided, and a target multimedia resource is edited based on the editing formula. As the editing formula is an editing method used by the user within a history time period, the target multimedia resource is directly edited by using the editing formula, which not only conforms to the user's habits, but also does not need to manually adjust the settings every time, which makes the operation simple, improving the human-computer interaction efficiency, thereby improving the editing efficiency of multimedia resources. In addition, on this basis, the filter and resource processing parameters in the editing formula can be adjusted according to the current requirements of the user, such that the edited target multimedia resource meets the user's habits.

All the above optional technical solutions may be combined in any way to form some embodiments of the present disclosure, which are thus not repeated herein.

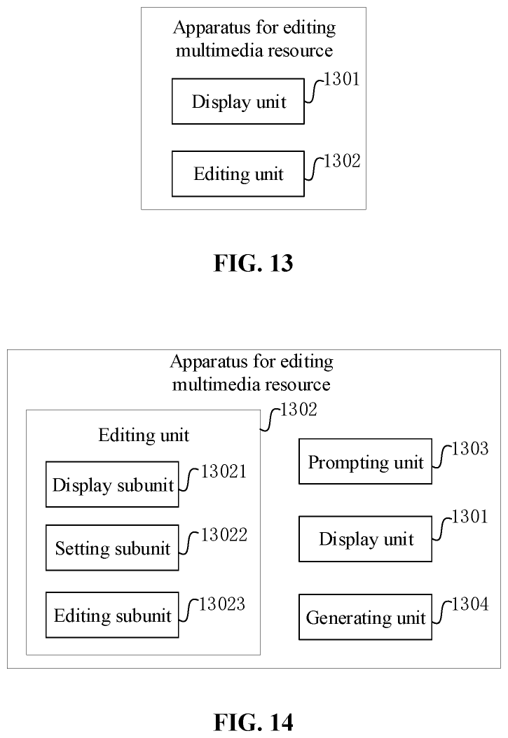

FIG. 13 is a block diagram of an apparatus for editing a multimedia resource according to some embodiments. Referring to FIG. 13, the apparatus includes: a display unit 1301 and an editing unit 1302, wherein
the display unit 1301 is configured to display a target multimedia resource to be edited and a formula control on a resource editing interface, wherein the formula control is configured to provide editing formulas for the target multimedia resource, and the editing formulas are generated based on filters indicated by a filter application operation and resource processing parameters indicated by an adjustment operation within a history time period;
the display unit 1301 is further configured to display, in response to a trigger operation on the formula control, the editing formulas on the resource editing interface; and
the editing unit 1302 is configured to edit, in response to a select operation on any of the editing formulas, the target multimedia resource based on a filter and resource processing parameters in the editing formula.

The embodiments of the present disclosure provide an apparatus for editing a multimedia resource, in which an editing formula generated based on a filter and resource processing parameters used in the case that a user edits the multimedia resource within a history time period is provided, and a target multimedia resource is edited based on the editing formula. As the editing formula is an editing method used by the user within a history time period, the target multimedia resource is directly edited by using the editing formula, which not only conforms to the user's habits, but also does not need to manually adjust the settings every time, which makes the operation simple, improving the human-computer interaction efficiency, thereby improving the editing efficiency of multimedia resources.

In some embodiments, FIG. 14 is a block diagram of another apparatus for editing a multimedia resource according to some embodiments. Referring to FIG. 14, the display unit 1301 is configured to display, in response to an edit operation on the target multimedia resource to be edited, the resource editing interface, wherein the target multimedia resource and a filter control are displayed on the resource editing interface; and display, in response to a trigger operation on the filter control, the formula control on an editing panel of the resource editing interface, wherein the formula control is displayed in a filter option of the editing panel in a form of a filter type label.

In some embodiments, referring to FIG. 14, the display unit 1301 is configured to display, in response to an edit operation on the target multimedia resource to be edited, the resource editing interface, wherein the target multimedia resource and an adjust control are displayed on the resource editing interface; in response to a trigger operation on the adjust control, an editing panel on the resource editing interface, wherein an adjust option and a filter option control are displayed on the editing panel, and the adjust option is configured to adjust resource processing parameters for the target multimedia resource; and replace, in response to a select operation on the filter option control, the adjust option on the editing panel with a filter option, wherein the filter option includes the formula control, and the formula control is displayed in the filter option in a form of a filter type label.

In some embodiments, referring to FIG. 14, the display unit 1301 is configured to display, in a case that the at least one editing formula is stored, the formula control to be in a triggerable state on the editing panel; and display, in a case that the at least one editing formula is not stored, the formula control to be in a non-triggerable state on the editing panel.

In some embodiments, referring to FIG. 14, the apparatus further includes:
a prompting unit 1303, configured to display, in response to the trigger operation on the formula control, prompt information in a case that the formula control is in the non-triggerable state, wherein the prompt information is configured to prompt that no editing formula is stored at the current moment.

In some embodiments, referring to FIG. 14, the display unit 1301 is configured to acquire, in response to the trigger operation on the formula control, generation times of the editing formulas; and display, according to a reverse order of the generation times, the editing formulas on the resource editing interface.

In some embodiments, referring to FIG. 14, the display unit 1301 is configured to acquire, in response to the trigger operation on the formula control, use frequencies of the editing formulas; and display, according to a reverse order of the use frequencies, the editing formulas on the resource editing interface.

In some embodiments, referring to FIG. 14, the display unit 1301 is configured to acquire, in response to the trigger operation on the formula control, history resource types corresponding to the editing formulas, wherein a history resource type corresponding to each editing formula is a type of a multimedia resource edited based on the editing formula within a history time period; and display, based on the history resource types corresponding to the editing formulas and a type of the target multimedia resource, the editing formulas on the resource editing interface.

In some embodiments, referring to FIG. 14, the editing unit 1302 is configured to display, in response to the select operation on any of the editing formulas, a filter bar of the editing formula, wherein a slide mark is displayed in the filter bar; adjust, in response to a slide operation on the slide mark, a filter parameter corresponding to the filter in the editing formula, wherein the filter parameter indicates a strength of the filter applied in the editing formula; and edit, based on the filter parameter as adjusted and the resource processing parameters in the editing formula, the target multimedia resource.

In some embodiments, referring to FIG. 14, the editing unit 1302 includes:
a display subunit 13021, configured to display, in response to a trigger operation on an adjusting-option control, adjust options in a case that any of the editing formulas is selected;
a setting subunit 13022, configured to set, in response to the trigger operation on any of the adjust options, resource processing parameters for the target multimedia resource; and
an editing subunit 13023, configured to edit, based on the editing formula and the resource processing parameters corresponding to the adjust options, the target multimedia resource.

In some embodiments, referring to FIG. 14, the editing subunit 13023 is configured to acquire the resource processing parameters indicated by the adjustment operation in the editing formula;

acquire target processing parameters by performing weighted summation on the resource processing parameters indicated by the adjustment operation and the resource processing parameters corresponding to the adjust options; and edit, based on the filter in the editing formula and the target processing parameters, the target multimedia resource.

In some embodiments, referring to FIG. 14, the editing subunit 13023 is configured to acquire resource processing parameters indicated by the adjustment operation in the editing formula; and edit, in a case that at least one adjust option is repeated with adjust options corresponding to the resource processing parameters in the editing formula, the target multimedia resource by taking the resource processing parameters corresponding to the at least one adjust option as a reference.

In some embodiments, referring to FIG. 14, the display unit 1301 is further configured to display, in response to the trigger operation on any of the adjust options, combined labels on a drawing track corresponding to the target multimedia resource in a case that any of the editing formulas is selected, wherein the drawing track includes multi-frame images of the target multimedia resource, the combined labels are marked with a name and an adjusting identifier of the editing formula, and the adjusting identifier indicates that an adjustment operation is present in an editing process of the target multimedia resource.

In some embodiments, a formula storage control is displayed on the resource editing interface; and referring to FIG. 14, the apparatus further includes:

a generating unit 1304, configured to generate, in response to a trigger operation on the formula storage control, a new editing formula based on the filter parameter or the resource processing parameters as adjusted.

It should be noted that, in the case that the apparatus for editing the multimedia resource provided in the foregoing embodiments edits the multimedia resource, the above-mentioned division of the functional units is merely exemplary. In practical applications, the above-mentioned functions can be assigned to different functional units according to needs; namely, the internal structure of the electronic device is divided into different functional units to complete all or part of the above-mentioned functions. In addition, the apparatus for editing the multimedia resource and the method for editing the multimedia resource provided in the foregoing embodiments belong to the same concept, and specific implementation processes thereof are described in detail in the method embodiments and are not repeated herein.

With regard to the apparatus in the above embodiments, the specific manner in which each module performs the operation has been described in detail in the embodiments related to the method, and will not be described in detail herein.

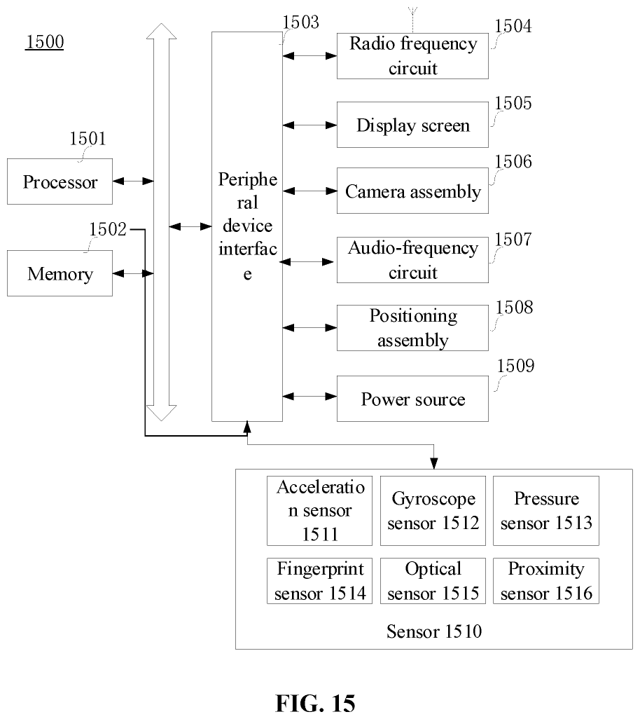

In the case that the electronic device is provided as a terminal, FIG. 15 is a block diagram of a terminal 1500 according to some embodiments. FIG. 15 shows a structural block diagram of the terminal 1500 according to some embodiments of the present disclosure. The terminal 1500 is a smart phone, a tablet computer, an MP3 player, an MP4 player, a laptop computer, or a desktop computer. The terminal 1500 is also referred to as user equipment, a portable terminal, a laptop terminal, a desktop terminal, or the like.

Generally, the terminal 1500 includes a processor 1501 and a memory 1502.

The processor 1501 includes one or more processing cores, such as a 4-core processor and an 8-core processor. The processor 1501 is implemented in at least one hardware form of a DSP (digital signal processor), an FPGA (field-programmable gate array), and a PLA (programmable logic array). The processor 1501 also includes a main processor and a coprocessor. The main processor is a processor defined to process data in an awake state, and is also referred to as a CPU (central processing unit). The coprocessor is a low-power processor defined to process data in a standby state. In some embodiments, the processor 1501 is integrated with a GPU (graphics processing unit) that is responsible for rendering and drawing contents that need to be displayed on a display screen. In some embodiments, the processor 1501 further includes an AI (artificial intelligence) processor for processing computing operations related to machine learning.

The memory 1502 includes one or more computer-readable storage media, which is non-transitory. The memory 1502 further includes a high-speed random access memory, and a non-volatile memory, such as one or more magnetic disk storage devices and flash storage devices. In some embodiments, the non-transitory computer-readable storage medium in the memory 1502 is defined to store at least one program code, wherein the at least one program code is defined to, when executed by the processor 1501, causes the electronic device to perform the method for editing the multimedia resource according to the method embodiments of the present disclosure.

In some embodiments, the terminal 1500 further optionally includes a peripheral device interface 1503 and at least one peripheral device. The processor 1501, the memory 1502, and the peripheral device interface 1503 are connected via buses or signal lines. The peripheral devices are connected to the peripheral device interface 1503 via a bus, signal line, or circuit board. In some embodiments, the peripheral devices include at least one of a radio frequency circuit 1504, a display screen 1505, a camera assembly 1506, an audio-frequency circuit 1507, a positioning assembly 1508, and a power source 1509.

The peripheral device interface 1503 is operable to connect at least one peripheral device related to input/output (I/O) to the processor 1501 and the memory 1502. In some embodiments, the processor 1501, the memory 1502, and the peripheral device interface 1503 are integrated on the same chip or circuit board. In some other embodiments, any one or two of the processor 1501, the memory 1502, and the peripheral device interface 1503 are implemented on a separate chip or circuit board, which is not limited in the embodiments of the present disclosure.

The radio frequency circuit 1504 is operable to receive and transmit a radio frequency (RF) signal, which is also referred to as an electromagnetic signal. The radio frequency circuit 1504 communicates with a communication network and other communication devices via electromagnetic signals. The radio frequency circuit 1504 converts an electrical signal into an electromagnetic signal for transmission, or converts a received electromagnetic signal into an electrical signal. In some embodiments, the radio frequency circuit 1504 includes an antenna system, an RF transceiver, one or more amplifiers, a tuner, an oscillator, a digital signal processor, a codec chipset, a subscriber identity module card, and the like. The radio frequency circuit 1504 communicates with other terminals via at least one wireless communication protocol. The wireless communication protocol includes, but is not limited to, a metropolitan area network, generations of mobile communication networks (2G, 3G, 4G, and 5G), a wireless local area network, and/or a wireless fidelity (WiFi) network. In some embodiments, the radio frequency circuit 1504 further includes a near field communication (NFC) related circuit, which is not limited in the present disclosure.

The display screen 1505 is operable to display a user interface (UI). The UI includes graphics, text, icons, videos, and any combination thereof. In the case that the display screen 1505 is a touch display screen, the display screen 1505 also has the capacity to acquire a touch signal on or above a surface of the display screen 1505. The touch signal is input to the processor 1501 as a control signal for processing. In this case, the display screen 1505 is also operable to provide virtual buttons and/or virtual keyboards, which are also referred to as soft buttons and/or soft keyboards. In some embodiments, there is one display screen 1505 disposed on a front panel of the terminal 1500; in some other embodiments, there are at least two display screens 1505 disposed on different surfaces of the terminal 1500, respectively, or in a folded design. In some still other embodiments, the display screen 1505 is a flexible display screen disposed on a curved surface or a folded surface of the terminal 1500. The display screen 1505 is even set to a non-rectangular irregular pattern, that is, a special-shaped screen. The display screen 1505 is prepared by using a material such as a liquid crystal display (LCD) or an organic light-emitting diode (OLED).

The camera assembly 1506 is operable to capture images or videos. In some embodiments, the camera assembly 1506 includes a front camera and a rear camera. Generally, the front camera is disposed on the front panel of the terminal, and the rear camera is disposed on a back side of the terminal. In some embodiments, there are at least two rear cameras, which are any one of a primary camera, a depth of field camera, a wide-angle camera, and a telephoto camera, such that the primary camera and the depth of field camera are combined to implement a bokeh function, the primary camera and the wide-angle camera are combined to implement panoramic shooting and virtual reality (VR) shooting functions, or other combined shooting functions are implemented. In some embodiments, the camera assembly 1506 further includes a flash. The flash is a single-color temperature flash or a two-color temperature flash. The two-color temperature flash is a combination of a warm-light flash and a cold-light flash, and is employed for light compensation at different color temperatures.

The audio-frequency circuit 1507 includes a microphone and a speaker. The microphone is operable to acquire sound waves of the user and the environment, and convert the sound waves into electrical signals for input into the processor 1501 for processing, or into the radio frequency circuit 1504 for voice communication. For the purpose of stereo acquisition or noise reduction, there is a plurality of microphones disposed at different parts of the terminal 1500, respectively. The microphone is also an array microphone or an omnidirectional acquisition microphone. The speaker is operable to convert the electrical signal from the processor 1501 or the radio frequency circuit 1504 into sound waves. The speaker is a conventional film speaker and is also a piezoelectric ceramic speaker. In the case that the speaker is a piezoelectric ceramic speaker, not only can the electrical signal be converted into sound waves that are audible to humans, but also the electrical signal can be converted into sound waves that are inaudible to humans for ranging and the like. In some embodiments, the audio-frequency circuit 1507 is also include a headphone jack.

The positioning component 1508 is configured to position the current geographic location of the terminal 1500 to implement navigation or a location-based service (LBS). The positioning component 80 may be the United States' Global Positioning System (GPS), Russia's Global Navigation Satellite System (GLONASS), China's BeiDou Navigation Satellite System (BDS), and the European Union's Galileo.

The power source 1509 is operable to supply power to the components in the terminal 1500. The power source 1509 is an alternating current, a direct current, a disposable battery, or a rechargeable battery. In the case that the power source 1509 includes a rechargeable battery, the rechargeable battery supports wired charging or wireless charging. The rechargeable battery is also operable to support fast charging.

In some embodiments, the terminal 1500 further includes one or more sensors 1510. The one or more sensors 1510 include, but are not limited to, an acceleration sensor 1511, a gyroscope sensor 1512, a pressure sensor 1513, a fingerprint sensor 1514, an optical sensor 1515, and a proximity sensor 1516.

The acceleration sensor 1511 is operable to detect accelerations on three coordinate axes of a coordinate system established by the terminal 1500. For example, the acceleration sensor 1511 is operable to detect components of the gravitational acceleration on the three coordinate axes. The processor 1501 controls the display screen 1505 to display the user interface in a landscape view or a portrait view based on a gravity acceleration signal acquired by the acceleration sensor 1511. The acceleration sensor 1511 is also operable to acquire game data or motion data of the user.

The gyroscope sensor 1512 detects a body direction and a rotation angle of the terminal 1500, and the gyroscope sensor 1512, together with the acceleration sensor 1511, acquires a 3D motion of the user to the terminal 1500. Based on the data acquired by the gyroscope sensor 1512, the processor 1501 implements the following functions: motion sensing (for example, changing the UI according to a tilting operation of the user), image stabilization during shooting, game control, and inertial navigation.

The pressure sensor 1513 is disposed at a side frame of the terminal 1500 and/or underneath the display screen 1505. In the case that the pressure sensor 1513 is disposed at the side frame of the terminal 1500, a holding signal of the user to the terminal 1500 is detected, and the processor 1501 performs left-right hand recognition or shortcut operation based on the holding signal acquired by the pressure sensor 1513. In the case that the pressure sensor 1513 is disposed underneath the display screen 1505, an operability control on the UI is controlled through the processor 1501 based on the pressure operation of the user on the display screen 1505. The operability control includes at least one of a button control, a scroll bar control, an icon control, and a menu control.

The fingerprint sensor 1514 is operable to acquire a fingerprint of the user, and the processor 1501 identifies the identity of the user based on the fingerprint acquired by the fingerprint sensor 1514, or the fingerprint sensor 1514 identifies the identity of the user based on the acquired fingerprint. Upon identifying that the identity of the user is a trusted identity, the processor 1501 authorizes the user to perform related sensitive operations, including unlocking the screen, viewing encrypted information, downloading software, paying, changing settings, and the like. The fingerprint sensor 1514 is disposed on the front side, back side or side surface of the terminal 1500. In the case that a physical key or a manufacturer logo is provided on the terminal 1500, the fingerprint sensor 1514 is integrated with the physical key or the manufacturer logo.

The optical sensor 1515 is operable to acquire ambient light intensity. In some embodiments, the processor 1501 controls the display brightness of the display screen 1505 based on the ambient light intensity acquired by the optical sensor 1515. In some embodiments, in the case of high ambient light intensity, the display brightness of the display screen 1505 is increased; in the case of low ambient light intensity, the display brightness of the display screen 1505 is lowered. In another embodiment, the processor 1501 also dynamically adjusts the shooting parameters of the camera assembly 1506 based on the ambient light intensity acquired by the optical sensor 1515.

The proximity sensor 1516, also known as a distance sensor, is typically disposed on the front panel of the terminal 1500. The proximity sensor 1516 is operable to acquire the distance between the user and the front side of the terminal 1500. In some embodiments, in the case that the proximity sensor 1516 detects that the distance between the user and the front side of the terminal 1500 is gradually decreasing, the processor 1501 controls the display screen 1505 to switch from a bright screen state into a blackout screen state; and in the case that the proximity sensor 1516 detects that the distance between the user and the front side of the terminal 1500 is gradually increasing, the processor 1501 controls the display screen 1505 to switch from the blackout screen state into the bright screen state.

In some embodiments, further provided is a non-transitory computer-readable storage medium storing instructions, such as the memory 1502 storing instructions. The instructions, when executing by the processor 1501 of the terminal 1500, cause the electronic device to perform the method for editing the multimedia resource described above. For example, the computer-readable storage medium is ROM, random-access memory (RAM), CD-ROM, magnetic tape, floppy disk, optical data storage device, etc.

Provided is a computer program product including computer programs/instructions. The computer programs/instructions, when executed by a processor, cause the electronic device to perform the method for editing the multimedia resource described above.

All embodiments of the present disclosure may be implemented alone or in combination with other embodiments and are considered to be within the protection scope of the present disclosure as claimed.

What is claimed is:

1. A method for editing a multimedia resource, applicable to an electronic device, comprising:
displaying a target multimedia resource to be edited and a formula control on a resource editing interface, wherein the formula control is configured to provide editing formulas for the target multimedia resource, and the editing formulas are generated based on filters indicated by a filter application operation and resource processing parameters indicated by an adjustment operation within a history time period;
displaying, in response to a trigger operation on the formula control, the editing formulas on the resource editing interface; and
editing, in response to a select operation on any of the editing formulas, the target multimedia resource based on a filter and resource processing parameters in the editing formula.

2. The method according to claim 1, wherein displaying the target multimedia resource to be edited and the formula control on the resource editing interface comprises:
displaying, in response to an edit operation on the target multimedia resource to be edited, the resource editing interface, wherein the target multimedia resource and a filter control are displayed on the resource editing interface; and
displaying, in response to a trigger operation on the filter control, the formula control on an editing panel of the resource editing interface, wherein the formula control is displayed in a filter option of the editing panel in a form of a filter type label.

3. The method according to claim 1, wherein displaying the target multimedia resource to be edited and the formula control on the resource editing interface comprises:
displaying, in response to an edit operation on the target multimedia resource to be edited, the resource editing interface, wherein the target multimedia resource and an adjust control are displayed on the resource editing interface;
displaying, in response to a trigger operation on the adjust control, an editing panel on the resource editing interface, wherein an adjust option and a filter option control are displayed on the editing panel, and the adjust option is configured to adjust resource processing parameters for the target multimedia resource; and
replacing, in response to a select operation on the filter option control, the adjust option on the editing panel with a filter option, wherein the filter option comprises the formula control, and the formula control is displayed in the filter option in a form of a filter type label.

4. The method according to claim 2, wherein displaying the formula control on the editing panel comprises:
displaying, in a case that at least one editing formula is stored, the formula control to be in a triggerable state on the editing panel; and
displaying, in a case that at least one editing formula is not stored, the formula control to be in a non-triggerable state on the editing panel.

5. The method according to claim 4, further comprising:
displaying, in response to the trigger operation on the formula control, prompt information in a case that the formula control is in the non-triggerable state, wherein the prompt information is configured to prompt that no editing formula is stored at current moment.

6. The method according to claim 1, wherein displaying, in response to the trigger operation on the formula control, the editing formulas on the resource editing interface comprises:
acquiring, in response to the trigger operation on the formula control, generation times of the editing formulas; and
displaying, according to a reverse order of the generation times starting from a latest generation time, the editing formulas on the resource editing interface, wherein a generation time is time when an editing formula was used to edit a multimedia resource.

7. The method according to claim 1, wherein displaying, in response to the trigger operation on the formula control, the editing formulas on the resource editing interface comprises:
acquiring, in response to the trigger operation on the formula control, use frequencies of the editing formulas; and
displaying, according to an order of high use frequencies to low use frequencies, the editing formulas on the resource editing interface.

8. The method according to claim 1, wherein displaying, in response to the trigger operation on the formula control, the editing formulas on the resource editing interface comprises:
acquiring, in response to the trigger operation on the formula control, history resource types corresponding to the editing formulas, wherein a history resource type corresponding to each editing formula is a type of a multimedia resource edited based on the editing formula within a history time period; and
displaying, based on the history resource types corresponding to the editing formulas and a type of the target multimedia resource, the editing formulas on the resource editing interface.

9. The method according to claim 1, wherein editing, in response to the select operation on any of the editing formulas, the target multimedia resource based on the filter and the resource processing parameters in the editing formula comprises:
displaying, in response to the select operation on any of the editing formulas, a filter bar of the editing formula, wherein a slide mark is displayed in the filter bar;
adjusting, in response to a slide operation on the slide mark, a filter parameter corresponding to the filter in the editing formula, wherein the filter parameter indicates a strength of the filter applied in the editing formula; and
editing, based on the filter parameter as adjusted and the resource processing parameters in the editing formula, the target multimedia resource.

10. The method according to claim 1, wherein editing, in response to the select operation on any of the editing formulas, the target multimedia resource based on the filter and the resource processing parameters in the editing formula comprises:
displaying, in response to a trigger operation on an adjusting-option control, adjust options in a case that any of the editing formulas is selected;
setting, in response to the trigger operation on any of the adjust options, resource processing parameters for the target multimedia resource; and
editing, based on the editing formula and the resource processing parameters corresponding to the adjust options, the target multimedia resource.

11. The method according to claim 10, wherein editing, based on the editing formula and the resource processing parameters corresponding to the adjust options, the target multimedia resource comprises:
acquiring the resource processing parameters indicated by the adjustment operation in the editing formula;
acquiring target processing parameters by performing weighted summation on the resource processing parameters indicated by the adjustment operation and the resource processing parameters corresponding to the adjust options; and
editing, based on the filter in the editing formula and the target processing parameters, the target multimedia resource.

12. The method according to claim 10, wherein editing, based on the editing formula and the resource processing parameters corresponding to the adjust options, the target multimedia resource comprises:
acquiring resource processing parameters indicated by the adjustment operation in the editing formula; and
editing, in a case that at least one adjust option is repeated with adjust options corresponding to the resource processing parameters in the editing formula, the target multimedia resource by taking the resource processing parameters corresponding to the at least one adjust option as a reference.

13. The method according to claim 10, comprising:
displaying, in response to the trigger operation on any of the adjust options, combined labels on a drawing track corresponding to the target multimedia resource in a case that any of the editing formulas is selected, wherein the drawing track comprises multi-frame images of the target multimedia resource, the combined labels are marked with a name and an adjusting identifier of the editing formula, and the adjusting identifier indicates that an adjustment operation is present in a editing process of the target multimedia resource.

14. The method according to claim 9, wherein a formula storage control is displayed on the resource editing interface; and
the method further comprises:
generating, in response to a trigger operation on the formula storage control, a new editing formula based on the filter parameter or the resource processing parameters as adjusted.

15. An electronic device, wherein the electronic device comprises:
one or more processors; and
a memory, configured to store program codes executable on the one or more processors,
wherein the one or more processors, when executing the program codes, are caused to perform:
displaying a target multimedia resource to be edited and a formula control on a resource editing interface, wherein the formula control is configured to provide editing formulas for the target multimedia resource, and the editing formulas are generated based on filters indicated by a filter application operation and resource processing parameters indicated by an adjustment operation within a history time period;
displaying, in response to a trigger operation on the formula control, the editing formulas on the resource editing interface; and
editing, in response to a select operation on any of the editing formulas, the target multimedia resource based on a filter and resource processing parameters in the editing formula.

16. The electronic device according to claim 15, wherein the one or more processors, when executing the program codes, are caused to perform:
displaying, in response to an edit operation on the target multimedia resource to be edited, the resource editing interface, wherein the target multimedia resource and a filter control are displayed on the resource editing interface; and
displaying, in response to a trigger operation on the filter control, the formula control on an editing panel of the resource editing interface, wherein the formula control is displayed in a filter option of the editing panel in a form of a filter type label.

17. The electronic device according to claim 15, wherein the one or more processors, when executing the program codes, are caused to perform:
displaying, in response to an edit operation on the target multimedia resource to be edited, the resource editing interface, wherein the target multimedia resource and an adjust control are displayed on the resource editing interface;
displaying, in response to a trigger operation on the adjust control, an editing panel on the resource editing interface, wherein an adjust option and a filter option control are displayed on the editing panel, and the adjust option is configured to adjust resource processing parameters for the target multimedia resource; and
replacing, in response to a select operation on the filter option control, the adjust option on the editing panel with a filter option, wherein the filter option comprises the formula control, and the formula control is displayed in the filter option in a form of a filter type label.

18. The electronic device according to claim 15, wherein the one or more processors, when executing the program codes, are caused to perform:
acquiring, in response to the trigger operation on the formula control, generation times of the editing formulas; and
displaying, according to a reverse order of the generation times starting from a latest generation time, the editing formulas on the resource editing interface.

19. The electronic device according to claim 15, wherein the one or more processors, when executing the program codes, are caused to perform:
acquiring, in response to the trigger operation on the formula control, use frequencies of the editing formulas; and
displaying, according to an order of high use frequencies to low user frequencies, the editing formulas on the resource editing interface.

20. A non-transitory computer-readable storage medium storing instructions therein, wherein the instructions, when executed by a processor of an electronic device, cause the electronic device to perform:
displaying a target multimedia resource to be edited and a formula control on a resource editing interface, wherein the formula control is configured to provide editing formulas for the target multimedia resource, and the editing formulas are generated based on filters indicated by a filter application operation and resource processing parameters indicated by an adjustment operation within a history time period;
displaying, in response to a trigger operation on the formula control, the editing formulas on the resource editing interface; and
editing, in response to a select operation on any of the editing formulas, the target multimedia resource based on a filter and resource processing parameters in the editing formula.
